(19) United States
(12) Patent Application Publication
(10) Pub. No.: US 2010/0266822 A1
(43) Pub. Date: Oct. 21, 2010

(54) PROCESS FOR PREPARING BLACK TONER FOR ELECTROPHOTOGRAPHY

(75) Inventors: Akihiro Eida, Wakayama-shi (JP); Takashi Okuno, Wakayama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KAO CORPORATION, Chuo-ku (JP)

(21) Appl. No.: 12/826,797

(22) Filed: Jun. 30, 2010

Related U.S. Application Data
(62) Division of application No. 11/423,792, filed on Jun. 13, 2006.

(30) Foreign Application Priority Data
Jul. 4, 2005 (JP) 2005-195577

(51) Int. Cl. B32B 3/10; G03G 13/20; G03G 9/08; G03G 9/087

(52) U.S. Cl. 428/195.1; 430/124.1; 430/110.1; 430/137.2

(57) ABSTRACT

A process for preparing a black toner for electrophotography, including the steps of (I) melt-kneading a raw material mixture containing a resin binder and a black colorant with an open-roller type kneader; (II) cooling the melt-kneaded mixture obtained in the step (I) and pulverizing the cooled mixture; and (III) classifying the pulverized product obtained in the step (II), wherein the resulting toner has a volume-median particle size (D₅₀v) of from 3 to 6.5 μm, contains 5.0% by volume or less of particles having particle sizes of (1.4×D₅₀v) μm or more, and contains 5.0% by number or less of particles having particle sizes of (0.6×number-median particle size (D₅₀p)) μm or less; and a black toner for electrophotography obtained by the process as defined above, wherein the toner is a toner for nonmagnetic monocomponent development. The black toner is used for development of a latent image formed in electrophotography, electrostatic recording method, electrostatic printing method, or the like.

This is a divisional application of U.S. application Ser. No. 11/423,792, filed Jun. 13, 2006.

### FIELD OF THE INVENTION

The present invention relates to a black toner for electrophotography used for, for example, development of a latent image formed in electrophotography, electrostatic recording method, electrostatic printing method, or the like, and a process for preparing the same.

### BACKGROUND OF THE INVENTION

Along with the widespread use of full color printers and the development of technology, the development of a toner capable of achieving higher printing speed and higher image qualities has been desired. Therefore, as a method for improving the durability and image qualities of toners including the step of increasing dispersibility of an internal additive such as a colorant, a method for preparing a toner with an open-roller type kneader has been known (see, for example, JP2004-20731 A and JP2004-177714 A).

### SUMMARY OF THE INVENTION

The present invention relates to:

[1] a process for preparing a black toner for electrophotography, including the steps of:
(I) melt-kneading a raw material mixture containing a resin binder and a black colorant with an open-roller type kneader;
(II) cooling the melt-kneaded mixture obtained in the step (I) and pulverizing the cooled mixture; and
(III) classifying the pulverized product obtained in the step (II),
wherein the resulting toner has a volume-median particle size (D₅₀v) of from 3 to 6.5 μm, contains 5.0% by volume or less of particles having particle sizes of (1.4×D₅₀v) μm or more, and contains 5.0% by number or less of particles having particle sizes of (0.6×number-median particle size (D₅₀p)) μm or less; and
[2] a black toner for electrophotography prepared by the above-mentioned process, wherein the toner is a toner for nonmagnetic monocomponent development.

### DETAILED DESCRIPTION OF THE INVENTION

The present invention relates to a process for preparing a black toner for electrophotography, capable of stably obtaining black fixed images having low gloss without impairing durability, and a black toner for electrophotography prepared by the process.

According to the present invention, a black toner for electrophotography, which has excellent durability and is capable of stably obtaining black fixed images having low gloss can be obtained.

These and other advantages of the present invention will be apparent from the following description.

When an open-roller type kneader is used, dispersibility of an internal additive increases, its kneading force is strong, so that a softening point of the resin is likely to be lowered, whereby the gloss of printed images is likely to be high. Therefore, although the process using an open-roller type kneader is suitable for the preparation of a color toner for color images favorable for fixed images having high gloss, the process may not be suitable for the preparation of a black toner for black fixed images favorable for images having low gloss in some cases.

On the other hand, when a kneading shear is weakened in consideration of gloss, while gloss is lowered, dispersibility of the internal additive is also worsened, which would lead to cause worsening in charging or generation of filming, thereby lowering the durability.

As a result of studies, the present inventors have found that gloss can be suppressed by adjusting a particle size distribution of the toner, even while an open-roller type kneader is used to increase dispersibility of the internal additive.

The process for preparing the toner of the present invention includes at least the steps of:

(I): melt-kneading a raw material mixture containing a resin binder and a black colorant with an open-roller type kneader;
(II): cooling the melt-kneaded mixture obtained in the step (I) and pulverizing the cooled mixture; and
(III): classifying the pulverized product obtained in the step (II).

Each of the steps will be explained hereinbelow.

The step (I) is a step of melt-kneading a raw material mixture containing a resin binder and a black colorant with an open-roller type kneader.

The resin binder includes polyesters, styrene-acrylic resins, resin mixtures of polyesters with styrene-acrylic resins, hybrid resins having two or more resin components, and the like. The resin binder preferably contains a polyester as a main component, from the viewpoint of dispersibility of the colorant and transparency. The content of the polyester is preferably from 50 to 100% by weight, and more preferably from 70 to 100% by weight, of the resin binder. As the hybrid resin, a resin in which a polycondensation resin such as a polyester, a polyester-polyamide or a polyamide, and an addition polymerization resin such as a vinyl polymerization resin are partially chemically bonded to each other is preferable. The hybrid resin may be obtained by using two or more resins as raw materials, or the hybrid resin may be obtained by using a mixture of one resin and raw material monomers for the other resin. In order to efficiently obtain a hybrid resin, those obtained from a mixture of raw material monomers for two or more resins are preferable.

The raw material monomer for the polyester is not particularly limited, and a known alcohol component and a known carboxylic acid component such as a carboxylic acid, a carboxylic acid anhydride, or a carboxylic acid ester, are used.

The alcohol component includes alkylene (2 to 3 carbon atoms) oxide (average number of moles: 1 to 16) adducts of bisphenol A such as polyoxypropylene(2.2)-2,2-bis(4-hydroxyphenyl)propane and polyoxyethylene(2.2)-2,2-bis(4-hydroxyphenyl)propane; ethylene glycol, propylene glycol, glycerol, pentaerythritol, trimethylolpropane, hydrogenated bisphenol A, sorbitol, alkylene (2 to 4 carbon atoms) oxide (average number of moles: 1 to 16) adducts thereof; and the like.

In addition, the carboxylic acid component includes dicarboxylic acids such as phthalic acid, isophthalic acid, terephthalic acid, fumaric acid, maleic acid, adipic acid, and succinic acid; a substituted succinic acid of which substituent is an alkyl group having 1 to 20 carbon atoms or an alkenyl group having 2 to 20 carbon atoms, such as dodecenylsuccinic acid and octenylsuccinic acid; tricarboxylic or higher polycarboxylic acids such as trimellitic acid and pyromellitic acid; acid anhydrides thereof; and alkyl(1 to 3 carbon atoms) esters thereof; and the like.

The polyester can be prepared by, for example, polycondensation of an alcohol component with a carboxylic acid component at a temperature of from 180° to 250° C. in an inert gas atmosphere in the presence of an esterification catalyst as desired.

The polyester has an acid value of preferably from 5 to 40 mg KOH/g, more preferably from 10 to 35 mg KOH/g, and even more preferably from 15 to 30 mg KOH/g.

Also, the polyester has a softening point of preferably from 70° to 180° C. and a glass transition temperature of preferably from 50° to 85° C.

In the present invention, it is preferable that the polyester contains two kinds of amorphous polyesters having a difference in softening point of 10° C. or more. Especially, from the viewpoint of obtaining a toner having low gloss, a combination of a high-softening point polyester having a softening point of 125° C. or more and 170° C. or less, preferably from 130° to 165° C., and more preferably from 135° to 160° C. with a low-softening point polyester having a softening point of 80° C. or more and less than 125° C., preferably from 85° to 120° C., and more preferably from 90° to 115° C. is desirable.

The weight ratio of the high-softening point polyester to the low-softening point polyester (high-softening point polyester/low-softening point polyester) is preferably from 10/90 to 90/10, and more preferably from 30/70 to 70/30.

Each of the high-softening point polyester and the low-softening point polyester may be a mixture of plural polyesters.

The resin binder is formulated in an amount of preferably from 70 to 99% by weight, and more preferably from 80 to 99% by weight, of the toner, from the viewpoint of fixing ability.

As the black colorant, all the dyes, pigments, or the like which are used as black colorants for toners can be used. The black colorant includes carbon black, aniline black, a nigrosine dye, a composite oxide, titanium black, perylene black, bone black, magnetite, and the like. From the viewpoint of gloss, carbon black is preferable.

The black colorant is formulated in an amount of preferably from 1 to 40 parts by weight, and more preferably from 3 to 10 parts by weight, based on 100 parts by weight of the resin binder. The toner may contain a colorant for a color toner for color tone or charge control, within the range that does not hinder the effects of the present invention.

In the present invention, the toner may further contain additives such as a releasing agent, a charge controlling agent, a fluidity improver, an electric conductivity modifier, an extender, a reinforcing filler such as a fibrous substance, an antioxidant, an anti-aging agent, a cleanability improver, and a magnetic material as a raw material.

The releasing agent includes waxes such as natural ester-based waxes such as carnauba wax and rice wax; synthetic waxes such as polypropylene wax, polyethylene wax, and Fischer-Tropsh wax; petroleum waxes such as paraffin waxes; coal waxes such as montan wax; and alcohol waxes. These releasing agents may be contained alone or in admixture of two or more kinds, and the natural ester-based wax may be a purified ester wax obtained by removing free fatty acids. In the present invention, a combined use of the natural ester-based wax and the petroleum wax is preferable, from the viewpoint of compatibility of the releasing agent with the polyester resins.

The releasing agent has a melting point of preferably from 50° to 120° C., and more preferably from 60° to 120° C., from the viewpoint of low-temperature fixing ability and offset resistance.

The releasing agent is formulated in an amount of preferably from 2 to 15% by weight, and more preferably from 4 to 10% by weight, of the toner, from the viewpoint of gloss and durability.

It is preferable that the raw materials such as a resin binder and a black colorant are pre-mixed with a Henschel mixer or the like, and subjected to the step of melt-kneading.

In the present invention, an open-roller type kneader is used for melt-kneading the raw materials. By using the open-roller type kneader, the black colorant can be efficiently subjected to high-dispersion without repeating the step of kneading or using a dispersion aid.

The open-roller type kneader in the present invention refers to a kneader containing at least two rollers, in which a melt-kneading member is an open type, and it is preferable to use a kneader containing at least two rollers, a heat roller and a cooling roller. The open-roller type kneader can easily dissipate the kneading heat generated during the melt-kneading. In addition, it is preferable that the open-roller type kneader is a continuous type kneader, from the viewpoint of production efficiency.

Further, in the above-mentioned open-roller type kneader, two of the rollers are arranged in parallel closely to each other, and the gap between the rollers is preferably from 0.01 to 5 mm, and more preferably from 0.05 to 2 mm. In addition, structures, sizes, materials, and the like of the roller are not particularly limited. Also, the surface of the roller may be any of smooth, wavy, rugged, or other surfaces.

The number of rotations of the roller, i.e., the peripheral speed of the roller, is preferably from 2 to 100 m/min. The peripheral speed of the cooling roller is preferably from 2 to 100 m/min, more preferably from 10 to 60 m/min, and even more preferably from 15 to 50 m/min. In addition, the two rollers preferably have different peripheral speeds from each other, and the ratio of the peripheral speed of the two rollers (cooling roller/heat roller) is preferably from 1/10 to 9/10, and more preferably from 3/10 to 8/10.

In order that the kneaded product is more likely to be adhered to the heat roller, it is preferable that the temperature of the heat roller is adjusted to be higher than both the softening point of the resin binder and the melting point of the wax, and that the temperature of the cooling roller is adjusted to be lower than both the softening point of the resin binder and the melting point of the wax. Specifically, the temperature of the heat roller is preferably from 80° to 200° C., and the temperature of the cooling roller is preferably from 20 to 140° C.

The difference in temperature between the heat roller and the cooling roller is preferably from 60° to 150° C., and more preferably from 80° to 120° C.

Here, the temperature of the roller can be adjusted by, for example, a temperature of a heating medium passing through the inner portion of the roller, and each roller may be divided in two or more portions in the inner portion of the roller, each being communicated with heating media of different temperatures.

It is preferable that the temperature of the heat roller, especially the raw material feeding side of the heat roller, is adjusted to be higher than the softening point of the resin binder and the melting point of each wax, more preferably a temperature calculated from the temperature higher than the higher of the softening point of the resin binder and the melting point of each wax plus 0° to 80° C., and even more preferably a temperature calculated from the temperature plus 5° to 50° C. It is preferable that the temperature of the cooling roller is adjusted to be lower than both of the softening point of the resin binder and the melting point of each wax, more preferably a temperature calculated from the temperature lower than the lower of the softening point of the resin binder and the melting point of each wax minus 0° to 80° C., and even more preferably a temperature calculated from the temperature minus 40° to 80° C.

The step (II) is a step of cooling the melt-kneaded mixture obtained in the step (I) and pulverizing the cooled mixture.

The temperature to which the melt-kneaded mixture is cooled is not particularly limited, as long as the melt-kneaded mixture is properly cooled to a pulverizable hardness.

The melt-kneaded mixture cooled in the step (II) may be pulverized once or in divided plural times. It is preferable that the pulverization includes two stages of rough pulverization and fine pulverization, from the viewpoints of pulverization efficiency and production efficiency. It is preferable that the melt-kneaded mixture is previously roughly pulverized to give a volume-median particle size (D₅₀) of from 10 to 1000 μm or so, and thereafter the resulting roughly pulverized product is further finely pulverized in consideration of the particle size of the desired toner.

In the step of roughly pulverizing the melt-kneaded mixture, Atomizer, Rotoplex, or the like can be used.

The pulverizer usable in the step of finely pulverizing the roughly pulverized product includes a jet type pulverizer such as a fluidized bed type jet mill and a gas stream type jet mill; a mechanical pulverizer such as a turbo mill; and the like. From the viewpoint of pulverization efficiency, the jet type pulverizer is preferable. Especially, when a jet type pulverizer is used in the preparation of a toner containing a wax, the wax can efficiently be present on the pulverized surface, and also an effect such as obtainment of a wide offset margin can be obtained.

The fluidized bed type jet mill usable in the present invention includes, for example, a pulverizer having the structure and principle for finely pulverizing the particles, comprising at least a pulverization chamber arranged facing two or more jet nozzles in its lower portion thereof, in which a fluidized bed is formed with the particles fed into the pulverizing container by a high-speed gas jet stream discharged from the jet nozzles wherein the particles are finely pulverized by repeating the acceleration of the particles and impact between the particles.

In the jet mill having the above-mentioned structure, the number of jet nozzles is not particularly limited. It is preferable that two or more jet nozzles, and preferably from 3 to 4 jet nozzles are arranged facing each other, from the viewpoints of balance between volume of air, amount of flow and flow rate, impact efficiency of the particles, and the like.

Further, a classifying rotor for capturing uplifted particles having small particle sizes downsized by pulverization is provided in an upper part of the pulverization chamber. The particle size distribution can be easily adjusted by a rotational speed of the classifying rotor. The finely pulverized product (classified powder obtained by cutting off its upper limit) can be obtained by classifying the pulverized product with the classifying rotor.

The classifying rotor may be arranged in any of longitudinal direction and latitudinal direction against the vertical direction. It is preferable that the classifying rotor is arranged in the longitudinal direction, from the viewpoint of classifying performance.

Specific examples of a fluidized bed type jet mill containing two or more jet nozzles and further containing a classifying rotor include pulverizers disclosed in JP-A-Showa-60-166547 and JP2002-35631 A.

The fluidized bed type jet mill which may be preferably usable in the present invention includes the “TFG” Series commercially available from Hosokawa Micron Corporation, the “AFG” Series commercially available from Hosokawa Micron Corporation, and the like.

In addition, the gas stream type jet mill includes, for example, an impact type jet mill containing a venturi nozzle and an impact member arranged so as to face the venturi nozzle, and the like.

The gas stream type jet mill which may be preferably usable in the present invention includes the “IDS” Series commercially available from Nippon Pneumatic Mfg. Co., Ltd., and the like.

The step (III) is a step of classifying the pulverized product obtained in the step (II).

The classifier usable in the step (III) includes air classifiers, rotor type classifiers, sieve classifiers, and the like. In the present invention, it is preferable that the classifier contains a classifying rotor comprising a driving shaft arranged in a casing as a central shaft thereof in a vertical direction, and a stationary spiral guiding vane arranged to share the same central shaft as the classifying rotor, wherein the stationary spiral guiding vane is arranged in a classification zone on an outer circumference of the classifying rotor with a given spacing to the outer circumference of the classifying rotor, from the viewpoint of ability of removing fine powders. Specific examples of the classifier having the structure described above include a classifier shown in FIG. 2 of JP-A-Hei-11-216425, a classifier shown in FIG. 6 of JP2004-78063 A, commercially available classifiers such as the “TSP” Series commercially available from Hosokawa Micron Corporation, and the like. The classification mechanism will be schematically explained hereinbelow.

The pulverized product fed into a casing of a classifier descends along a classification zone on the outer circumference of the classifying rotor while being led by the spiral guiding vane. The inner part of the classifying rotor and the classification zone are communicated via a classifying vane provided on the surface of the outer circumference of the classifying rotor. When the pulverized product is descended, fine powders carried along with a classifying air are aspirated to the inner part of the classifying rotor via the classifying vane, and discharged from a discharging outlet for fine powders. On the other hand, coarse powders that are not carried along with the classifying air are descended along the classification zone by gravitational force, and discharged from a discharging outlet for coarse powders.

Further, it is preferable that the classifier usable in the step (III) has two classifying rotors sharing the same driving shaft as a central shaft thereof in one casing, and that each of the classifying rotors independently rotates in the same direction. Specific examples of the classifiers provided with a classifying rotor on each of two top and bottom stages include a classifier shown in FIG. 1 of JP2001-293438 A, commercially available classifiers such as the “TTSP” Series commercially available from Hosokawa Micron Corporation, and the like.

When a classifying rotor is provided on each of two top and bottom stages, it is more preferable because an even higher precision classification can be achieved by adjusting an aspiration rate of classifying air, a rotational speed in each classifying rotor, or the like.

For example, the ratio of the rotational speed of the upper classifying rotor to the rotational speed of the lower classifying rotor (the rotational speed of the upper classifying rotor/the rotational speed of the lower classifying rotor) is preferably from 1/1.05 to 1.05/1, and more preferably 1/1, from the viewpoint of preventing turbulence.

In addition, it is preferable that the amount of air flow led from an upper air aspiration inlet to the amount of air flow led from a lower air aspiration inlet (amount of air flow led from upper air aspiration inlet/amount of air flow led from lower air aspiration inlet) is nearly equal, from the viewpoint of classification precision and yield of toner.

It is preferable that the classifier usable in the step (III) is mainly usable in the classification on the fine powder side (classification to cut off its lower limit) in order to remove fine powders. The fine powders removed during the classifying step may be subjected to the step (III) so as to recapture the necessary portion of the fine powders by re-classification.

The toner of the present invention can be obtained at least through the above-mentioned steps (I) to (III), and an external additive may further be added to the toner obtained by the step (III).

The external additive is preferably an inorganic oxide such as silica, titania, alumina, zinc oxide, magnesium oxide, cerium oxide, iron oxide, copper oxide, or tin oxide. Among them, silica is preferable, from the viewpoint of giving chargeability.

Fine powders of silica (SiO₂) may be prepared by any of dry method or wet method. In addition, besides anhydrous silica, the fine powders of silica may contain aluminum silicate, sodium silicate, potassium silicate, magnesium silicate or zinc silicate, of which SiO₂ content is 85% by weight or more is preferable.

In addition, the surface of the external additive may be subjected to hydrophobic treatment. The hydrophobic treatment method is not particularly limited. The hydrophobic treatment agent includes silane coupling agents such as hexamethyl disilazane (HMDS) and dimethyl dichlorosilane (DMDS); silicone oil treatment agents such as dimethyl silicone oil and amino-modified silicone oil; and the like. Among them, silane coupling agents are preferable. The amount treated by the hydrophobic treatment agent is preferably from 1 to 7 mg/m² per surface area of the external additive.

The external additive has an average particle size of preferably from 8 to 200 nm, and more preferably from 12 to 100 nm, from the viewpoint of adhesion to the surface of the toner. Here, the average particle size is a number-average particle size.

The toner obtained according to the present invention has a softening point of preferably from 90° to 135° C., and more preferably from 100° to 125° C., from the viewpoint of the adjustment of gloss when the toner is used in combination with a color toner.

One of the great features of the present invention resides in the particle size distribution of the resulting toner. By adjusting the particle size distribution of the toner within a specified range by the pulverizing step or the classifying step, increase in the gloss can be suppressed, even while a kneading shear is applied with an open-roller type kneader.

When the particle size of the toner is too large, the thickness of the layer of the toner after fixing becomes thick, so that the surface thereof is likely to be smoothened, and whereby consequently gloss is likely to increase. Therefore, by downsizing the particle size of the toner, the thickness of the layer of the toner after fixing is thinned, and whereby gloss can be suppressed. From this viewpoint, the toner obtained according to the present invention has a volume-median particle size (D₅₀v) of from 3 to 6.5 μm, preferably from 3.0 to 6.0 μm, and more preferably from 3.0 to 5.5 μm. In addition, the toner has a number-median particle size (D₅₀p) of preferably from 2.5 to 6.0 μm, and more preferably from 2.5 to 5.5 μm. The volume-median particle size (D₅₀v) as referred to herein means a particle size corresponding to a 50% cumulative volume frequency calculated by the volume fraction of the toner, counting from the side of smaller particle size. The number-median particle size (D₅₀p) means a particle size corresponding to a 50% cumulative number frequency, counting from the side of smaller particle size.

Further, even while the toner has a small median particle size, when the toner has a broad particle size distribution, it is not desirable for the following reasons. For example, particles on the coarse powder side form thicker thickness of the layer of the toner, thereby resulting in increase in gloss, and a toner on the fine powder side is present so as to fill the gaps between toner particles, thereby having an effect of smoothening the thickness of the layer of the toner after fixing. From these viewpoints, the content of particles having particle sizes of (1.4×D₅₀v) μm or more is 5.0% by volume or less, preferably 4.0% by volume or less, and more preferably 3.0% by volume or less, of the toner. On the other hand, the content of particles having particle sizes of (0.6×D₅₀p) μm or less in the toner is 5.0% by number or less, preferably 4.0% by number or less, and more preferably 3.0% by number or less, of the toner.

The toner of the present invention can be excellently fixed by an oil-less fixing process. Here, the oil-less fixing process refers to a process for fixing a toner with a heat roller fixing device but without an oil-feeding device, or the like. The oil-feeding device includes a device comprising an oil tank and having mechanism of applying an oil to a heat roller surface in a given amount; a device having mechanism so as to contact a roller previously immersed in an oil with a heat roller; and the like.

Accordingly, the present invention further provides a process for forming fixing images, including the step of fixing the toner of the present invention by an oil-less fixing process. The process for forming fixing images of the present invention allows the fixing images to be formed through known steps except that the fixing step including a step of fixing a transferred toner image has the above feature. Representative steps in the process for forming fixing images include the steps of forming an electrostatic latent image on the surface of a photoconductor (charging and exposing step); developing the electrostatic latent image (developing step); transferring the developed toner image to a material to be transferred such as paper (transferring step); removing the toner remaining on a developing member such as a photoconductive drum (cleaning step), and the like.

The black toner for electrophotography obtained by the present invention can be used without particular limitation in any of the development methods alone as a toner for monocomponent development or a toner for two component development prepared by mixing the toner with a carrier. It is preferable that the toner of the present invention is used as a black toner for non-magnetic monocomponent development because the toner is excellent in dispersion of a black colorant, especially carbon black, and has high chargeability.

### EXAMPLES

The following examples further describe and demonstrate embodiments of the present invention. The examples are given solely for the purposes of illustration and are not to be construed as limitations of the present invention.

### [Softening Point]

The softening point refers to a temperature at which a half of the sample flows out when plotting a downward movement of a plunger against temperature, when measured by using a flow tester (CAPILLARY RHEOMETER “CFT-500D,” commercially available from Shimadzu Corporation), in which a 1 g sample is extruded through a nozzle having a die pore size of 1 mm and a length of 1 mm, while heating the sample so as to raise the temperature at a rate of 6° C./min and applying a load of 1.96 MPa thereto with the plunger.

### [Glass Transition Temperature of Resins]

The glass transition temperature refers to a temperature of an intersection of the extension of the baseline of equal to or lower than the temperature of the maximum endothermic peak and the tangential line showing the maximum inclination between the kick-off of the peak and the top of the peak, which is determined using a differential scanning calorimeter (“DSC 210,” commercially available from Seiko Instruments, Inc.), by raising its temperature to 200° C., cooling the sample from this temperature to 0° C. at a cooling rate of 10° C./min, and thereafter raising the temperature of the sample at a rate of 10° C./min.

### [Acid Value of Resin]

The acid value is determined in accordance with JIS K0070, except that only the solvent used for the determination is changed from a mixed solvent of ethanol and ether to a mixed solvent of acetone and toluene (acetone:toluene=1:1 (volume ratio)).

### [Particle Size Distribution of Toner]

The particle size distribution of the toner is determined with a coulter counter “Coulter Multisizer II” (commercially available from Beckman Coulter) according to the following method.

(1) Preparation of Dispersion: 10 mg of a sample to be measured is added to 5 ml of a dispersion medium (a 5% by weight aqueous solution of “EMULGEN 109P” (commercially available from Kao Corporation, polyoxyethylene lauryl ether, HLB: 13.6)), and dispersed with an ultrasonic disperser for one minute. Thereafter, 25 ml of electrolytic solution (“Isotone II” (commercially available from Beckman Coulter)) is added thereto, and the mixture is further dispersed with the ultrasonic disperser for one minute, to give a dispersion.
(2) Measuring Apparatus: Coulter Multisizer II (commercially available from Beckman Coulter)

Aperture Diameter: 100 μm

Range of Particle Sizes to Be Determined: 2 to 60 μm

Analyzing Software: Coulter Multisizer AccuComp Ver. 1.19

(commercially available from Beckman Coulter)
(3) Measurement Conditions: One-hundred milliliters of an electrolyte and a dispersion are added to a beaker, and the particle sizes of 30000 particles are determined under the conditions for concentration satisfying that the determination for 30000 particles are completed in 20 seconds.
(4) The volume-median particle size (D₅₀v, μm), the number-median particle size (D₅₀p, μm), the content (% by volume) of the particles having particle sizes of (1.4×D₅₀v) μm or more, and the content (% by number) of the particles having particle sizes of (0.6×D₅₀p) μm or less are obtained from the found values.

### Preparation Example 1 of Resin

A 5-liter four-necked flask equipped with a nitrogen inlet tube, a dehydration tube, a stirrer, and a thermocouple was charged with 1286 g of polyoxypropylene(2.2)-2,2-bis(4-hydroxyphenyl)propane, 2218 g of polyoxyethylene(2.2)-2,2-bis(4-hydroxyphenyl)propane, 1603 g of terephthalic acid, and 10 g of tin octylate, and the ingredients were reacted at 230° C. under a nitrogen atmosphere, until the reactivity reached 90%. Thereafter, the reaction mixture was reacted at 8.3 kPa, until the temperature reached a desired softening point, to give a resin A. The resulting resin A had a softening point of 111.4° C., a glass transition temperature of 68.5° C., and an acid value of 3.2 mg KOH/g. Here, the reactivity refers to a value calculated from (amount of water formed in the reaction mixture (mol))/(a theoretical amount of water formed)×100.

### Preparation Example 2 of Resin

A 5-liter four-necked flask equipped with a nitrogen inlet tube, a dehydration tube, a stirrer, and a thermocouple was charged with 2450 g of polyoxypropylene(2.2)-2,2-bis(4-hydroxyphenyl)propane, 975 g of polyoxyethylene(2.2)-2,2-bis(4-hydroxyphenyl)propane, 1145 g of terephthalic acid, 172 g of dodecenylsuccinic acid, and 10 g of tin octylate, and the ingredients were reacted at 230° C. under a nitrogen atmosphere, until the reactivity reached 90%, and thereafter reacted at 8.3 kPa for one hour. Thereafter, the reaction mixture was cooled to 210° C., and 480 g of trimellitic anhydride was supplied thereto to react the mixture at normal pressure for one hour. Thereafter, the reaction mixture was reacted at 8.3 kPa, until the temperature reached a desired softening point, to give a resin B. The resulting resin B had a softening point of 146.8° C., a glass transition temperature of 73.4° C., and an acid value of 23.9 mg KOH/g.

### Example 1

Sixty parts by weight of the resin A, 40 parts by weight of the resin B, 4.5 parts by weight of a carbon black “MOGUL L” (commercially available from Cabot Corporation), 4.0 parts by weight of a carnauba wax “Carnauba Wax C1” (commercially available from Kato Yoko), 3.0 parts by weight of a paraffin wax “HNP-9” (commercially available from Nippon Seiro), and 0.2 parts by weight of a charge control agent “BONTRON E-304” (commercially available from Orient Chemical Co., Ltd.) were mixed with a Henschel mixer, and the resulting mixture was melt-kneaded with a continuous twin open-roller type kneader “Kneadex” (commercially available from MITSUI MINING COMPANY, LIMITED), to give a kneaded mixture.

Incidentally, the continuous twin open-roller type kneader used has a roller having an outer diameter of 0.14 m and an effective length of 0.8 m, and the operating conditions are a rotational speed of a higher rotation side roller (front roller) of 75 r/min, a rotational speed of a lower rotation side roller (back roller) of 50 r/min, and a gap between the rollers of 0.1 mm. The temperature of the heating medium and the cooling medium inside the rollers are as follows. The higher rotation side roller has a temperature at the raw material supplying side of 150° C., and a temperature at the kneaded mixture discharging side of 130° C., and the lower rotation side roller has a temperature at the raw material supplying side of 35° C., and a temperature at the kneaded mixture discharging side of 30° C. In addition, the feeding rate of the raw material mixture was 10 kg/hour.

Next, the resulting kneaded mixture was cooled in the air, and thereafter the cooled mixture was roughly pulverized with Alpine Rotoplex (commercially available from Hosokawa Micron Corporation), to give a roughly pulverized product having the maximum particle size of 2 mm.

The amount 1.5 parts by weight of a hydrophobic silica “R972” (commercially available from Nippon Aerosil, hydrophobic treatment agent: DMDS, average particle size: 16 nm) was mixed with a Henschel mixer, based on 100 parts by weight of the resulting roughly pulverized product. The resulting roughly pulverized product was finely pulverized and classified by cutting off its upper limit (removal of coarse powers) with a counter jet mill “400AFG” (commercially available from Hosokawa Micron Corporation).

Further, the finely pulverized product was classified by cutting off its lower limit (removal of fine powders) with a classifier “TTSP” (commercially available from Hosokawa Micron Corporation), to give a toner. The particle size distribution of the resulting toner is shown in Table 1. Further, 1.0 part by weight of a hydrophobic silica “R972” (commercially available from Nippon Aerosil) was externally added, based on 100 parts by weight of the resulting toner, to give a toner.

### Example 2 and Comparative Examples 1 to 3

The same procedures as in Example 1 were carried out except that the particle size distribution of the toner was adjusted as shown in Table 1, to give a toner, and a hydrophobic silica was externally added thereto.

### Example 3

The same procedures as in Example 1 were carried out except that a dispersion separator “DS” (commercially available from Nippon Pneumatic Mfg. Co., Ltd.) was used as a classifier in place of “TTSP,” to give a toner, and a hydrophobic silica was externally added thereto.

### Comparative Example 4

The same procedures as in Example 1 were carried out except that a twin-screw extruder “PCM-30” was used in place of the continuous twin open-roller type kneader, to give a toner, and a hydrophobic silica was externally added thereto.

### Test Example

A toner was loaded to a nonmagnetic monocomponent development device “MicroLine 9500PS” (commercially available from Oki Data Corporation) adopting an oil-less fixing process to print solid images, and the gloss of the solid images was determined. It is preferable that business documents have a gloss of 25 or less. The gloss was determined using a glossmeter “PG-1” (commercially available from Nippon Denshoku Kogyo K.K.) with its light source being set at 60°.

Further, a continuous printing was carried out for 6,000 sheets at a printing ratio of 5%, to confirm whether or not filming is generated on a blade. The results are shown in Table 1.

TABLE 1

| | | Particle Size Distribution of Toner | | | | | |
|---|---|---|---|---|---|---|---|
| | Softening | | | Particles Having | Particles Having | | |
| | Point of | | | Particle Sizes of | Particle Sizes of | | |
| | Toner | | | (1.4 × D₅₀v) or More | (0.6 × D₅₀p) or Less | | Generation |
| | (° C.) | D₅₀v | D₅₀p | (% by vol.) | (% by num.) | Gloss | of Filming |
| Ex. No. | | | | | | | |
| 1 | 115 | 5.5 | 4.9 | 2.5 | 2.5 | 19 | Absent |
| 2 | 114 | 6.3 | 5.8 | 3.1 | 3.4 | 21 | Absent |
| 3 | 115 | 5.8 | 5.5 | 2.8 | 4.2 | 20 | Absent |
| Comp. | | | | | | | |
| Ex. No. | | | | | | | |
| 1 | 116 | 7.0 | 6.5 | 3.2 | 3.5 | 28 | Absent |
| 2 | 115 | 5.5 | 5.0 | 5.6 | 3.2 | 26 | Absent |
| 3 | 115 | 5.5 | 4.7 | 4.0 | 5.5 | 27 | Absent |
| 4 | 122 | 5.6 | 5.1 | 4.1 | 4.1 | 18 | Present |

It can be seen from the above results that a toner having low gloss and excellent durability is obtained in each Example. On the other hand, in Comparative Examples 1 to 3 where an open-roller type kneader was used but the particle size distribution of the toner was not adjusted to a desired range, the toner has excellent durability but increase in gloss cannot be suppressed; and in Comparative Example 4 where the raw material mixture was melt-kneaded with a twin-screw extruder, the gloss is low, but the durability is lowered.

The black toner for electrophotography obtainable by the present invention is used for development of a latent image formed in electrophotography, electrostatic recording method, electrostatic printing method, or the like.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An oil-less fixing process for fixing a black fixed image using a black toner, which process comprises:
(I) melt-kneading a raw material mixture comprising a resin binder and a black colorant with an open-roller type kneader;
(II) cooling the melt-kneaded mixture obtained in the step (I) and pulverizing the cooled mixture;
(III) classifying the pulverized product obtained in the step (II), wherein the resulting toner has a volume-median particle size (D₅₀v) of from 3 to 6.5 μm, contains 3.1% by volume or less of particles having particle sizes of (1.4×D₅₀v) μm or more, and contains 4.2% by number or less of particles having particle sizes of (0.6×number-median particle size (D₅₀p)) μm or less, and
(IV) forming an image using the toner in an oil-less fixing process,
wherein said image formed by the oil-less fixing process has a lower gloss than an image formed from the same oil-less fixing process and from an otherwise identical black toner but having at least one of (1) a volume-median particle size (D₅₀v) of greater than 6.5 μm, (2) more than 5% by volume of particles having particle sizes of (1.4×D₅₀v) μm or more, and (3) more than 5% by number or less of particles having particle sizes of (0.6×number-median particle size (D₅₀p)) μm or less.

2. The process according to claim 1, wherein the step (III) comprises classifying the pulverized product with a classifier, the classifier comprising a classifying rotor comprising a driving shaft arranged in a casing as a central shaft thereof in a vertical direction, and a stationary spiral guiding vane arranged to share the same central shaft as the classifying rotor, wherein the stationary spiral guiding vane is arranged in a classification zone on an outer circumference of the classifying rotor with a given spacing to the outer circumference of the classifying rotor.

3. The process according to claim 1, wherein the pulverization in the step (II) comprises rough pulverization and fine pulverization, the fine pulverization comprising finely pulverizing the roughly pulverized product with a jet type pulverizer.

4. The process according to claim 1, wherein the resin binder comprises two kinds of polyesters having a difference in softening point of 10° C. or more.

5. The process according to claim 4, wherein the two kinds of polyesters are a high-softening point polyester having a softening point of 125° C. or more and 170° C. or less, and a low-softening point polyester having a softening point of 80° C. or more and less than 125° C.

6. The process according to claim 5, wherein the weight ratio of the high-softening point polyester to the low-softening point polyester is from 10/90 to 90/10.

7. The process according to claim 1, wherein the black colorant is a carbon black.

8. The process according to claim 1, wherein the black colorant is formulated in an amount of from 1 to 40 parts by weight, based on 100 parts by weight of the resin binder.

9. The process according to claim 1, wherein the raw material mixture further comprises a releasing agent having a melting point of from 50° to 120° C., wherein the releasing agent is formulated in an amount of from 2 to 15% by weight of the toner.

10. The process according to claim 1, wherein the open-roller type kneader comprises two rollers arranged in parallel closely to each other, wherein the gap between the two rollers is from 0.01 to 5 mm.

11. The process according to claim 10, wherein the two rollers comprise a heat roller and a cooling roller, the heat roller and the cooling roller having a difference in temperature of from 60° to 150° C.

12. The process according to claim 1, wherein the resulting toner has a softening point of from 90° to 135° C.

13. The process according to claim 1, wherein the image has a gloss of 25 or less measured at 60° C.

14. The process according to claim 13, wherein the gloss is 19-21.

15. A fixed image obtained by the process of claim 1, wherein the image has a gloss of 25 or less measured at 60° C.

16. The fixed image according to claim 15, wherein the gloss is 19-21.

17. The process of claim 1, wherein the forming comprises charging and exposing an electrostatic latent image on the surface of a photoconductor;
developing the electrostatic latent image; transferring the developed toner image to a material to be transferred, and
fixing the toner image by oil-less fixing.

18. The process of claim 1, wherein the classifying forms a toner having from 2.5 to 3.1% by volume of particles having the particle size of (1.4×D₅₀v) and from 2.5 to 4.2% by number of particles having a particle size of (0.6×D₅₀p) or less.

19. The process of claim 18, wherein D₅₀v is from 5.5 to 6.3 and D₅₀p is from 4.9 to 5.8.

20. The process according to claim 1, wherein the resin binder comprises a high softening point polyester and a low softening point polyester,
wherein the high softening point polyester and the low softening point polyester comprise reacted units of an alkylene oxide adduct of bispenol A component and a carboxylic acid component,
wherein the alkylene oxide adduct of bispenol A component has an alkylene group having 2-3 carbon atoms and the average number of moles of the alkylene oxide per mole of the alkylene oxide adduct of bispenol A is from 1 to 16.

21. The process according to claim 1, wherein the raw material mixture comprises two kinds of polyesters, a high-softening point polyester having a softening point of 135° C. or more and 160° C. or less, and a low-softening point polyester having a softening point of 90° C. or more and less than 115° C., wherein the weight ratio of the high-softening point polyester to the low-softening point polyester is from 30/70 to 70/30, and a releasing agent having a melting point of from 60° to 120° C. in an amount of from 4 to 10% by weight of the toner; and the resulting toner in step (III) has a volume-median particle size (D₅₀v) of from 5.5 to 6.3 μm.

22. The process according to claim 21, wherein the high softening point polyester and the low softening point polyester comprise reacted units of an alkylene oxide adduct of bispenol A component and a carboxylic acid component, and wherein the alkylene oxide adduct of bispenol A component has an alkylene group having 2-3 carbon atoms and an average number of moles of the alkylene oxide per mole of the alkylene oxide adduct of bispenol A of from 1 to 16.

23. The process according to claim 1, wherein the resin binder comprises a high softening point polyester and a low softening point polyester, and wherein the low softening point polyester comprises reacted units of polyoxypropylene(2.2)-2,2-bis(4-hydroxyphenyl)propane, polyoxyethylene(2.2)-2,2-bis(4-hydroxyphenyl)propane and terephthalic acid, and the high softening point polyester comprises reacted units of polyoxypropylene(2.2)-2,2-bis(4-hydroxyphenyl)propane, polyoxyethylene(2.2)-2,2-bis(4-hydroxyphenyl)propane, terephthalic acid and dodecenyl succinic acid.

24. The process according to claim 21, wherein the low softening point polyester comprises reacted units of polyoxypropylene(2.2)-2,2-bis(4-hydroxyphenyl)propane, polyoxyethylene(2.2)-2,2-bis(4-hydroxyphenyl)propane and terephthalic acid, and the high softening point polyester comprises reacted units of polyoxypropylene(2.2)-2,2-bis(4-hydroxyphenyl)propane, polyoxyethylene(2.2)-2,2-bis(4-hydroxyphenyl)propane, terephthalic acid and dodecenyl succinic acid.

25. A black toner for electrophotography obtained by a process which comprises:
(I) melt-kneading a raw material mixture comprising a resin binder and a black colorant with an open-roller type kneader;
(II) cooling the melt-kneaded mixture obtained in the step (I) and pulverizing the cooled mixture;
(III) classifying the pulverized product obtained in the step (II), wherein the resulting toner has a volume-median particle size (D₅₀v) of from 3 to 6.5 μm, contains 3.1% by volume or less of particles having particle sizes of (1.4×D₅₀v) μm or more, and contains 4.2% by number or less of particles having particle sizes of (0.6×number-median particle size (D₅₀p)) μm or less, wherein the toner is a toner for nonmagnetic monocomponent development.
